(19) United States
(12) Patent Application Publication
(10) Pub. No.: US 2002/0101307 A1
(43) Pub. Date: Aug. 1, 2002

(54) Loop coupled microwave cavity

(76) Inventors: Ji-Chyun Liu, Tao-yuan (TW); Chung-Chi Chang, Hsinchu (TW); Ju-Chi Chung, Tao-yuan (TW)

Correspondence Address: RABIN & CHAMPAGNE, PC, 1101 14TH STREET, NW, SUITE 500, WASHINGTON, DC, 20005, US

(21) Appl. No.: 09/894,888

(22) Filed: Jun. 29, 2001

(30) Foreign Application Priority Data
Dec. 14, 2000 (TW) 89126681

(51) Int. Cl. H01P 7/06; H01P 5/103

(52) U.S. Cl. 333/230; 333/26; 333/33

(57) ABSTRACT

A loop coupled microwave cavity, which uses a cylindrical cavity as the main body and has a lock hole on the top of the cavity in order to connect to a loop-coupling end formed by bending the long pin of a SMA connector. The long pin of the SMA extends into the cavity through the lock hole so that the top end of the long pin will touch the inner wall of the cavity to receive a microwave signal in TM₀₁₂ mode to excite the cavity. On the other hand, the coaxial structure formed by the long pin and the lock hole is a quarter-wavelength transformer, so the SMA connector has both loop coupling and transforming functions to increase the Q factor of the cavity. A diminutive sample is inserted into the cavity to perform the cavity perturbation method (CPM).

This application incorporates by reference Taiwanese application Serial No. 89126681, Filed Dec. 14, 2000.

### BACKGROUND OF THE INVENTION

1. Field of the Invention

The invention relates in general to a microwave cavity, and more particularly to a cylindrical resonant cavity that measures the dielectric characteristics of various materials.

2. Description of the Related Art

The applications of microwave technology have attracted the attention of researchers and industry and these applications include: material characteristics measurement, nondestructive detecting, communication, radar, medical science, biochemistry and agriculture. Since the related research requires knowing precisely the material's dielectric characteristics, the researchers have devoted themselves to the exploration of dielectric material. This makes the development of microwave technology more prosperous.

In the electronics industry, the improvements of the microwave engineering makes high frequency communication technology more advanced, from the early days of satellite transmission to the personal portable communication devices. The process of high frequency circuit fabrication is to form the layout on the circuit board first, and after the completion of the layout, the related components are assembled to complete the whole circuit. It is important to realize that since the circuit board is a kind of dielectric material and the electric characteristics are decided by the individual parameters of the dielectric material. Therefore, one must master the dielectric characteristics of the circuit board before starting the circuit design. Thus, the parameters such as permittivity, loss tangent and the Q factor are essential information to make sure the quality of the circuit board is as expected. There are many measuring techniques available for measuring the parameters of dielectric materials, for example, wave-guide method, transmission method, microstrip line method, cavity perturbation method (CPM) and quasi-optical resonator method. Among these methods, CPM and quasi-optical resonator method produce the lowest loss in measuring the loss tangent. The paragraphs below contain the explanation about the CPM.

The CPM involves placing a diminutive sample into the cavity to cause perturbation and change the resonant frequency of the cavity and its Q factor, so the dielectric characteristics of the sample can be calculated from the quantity of those changes. Since CPM is particularly suitable for measuring the dielectric materials having a high Q factor, it is favored by most researchers.

Referring to FIG. 1, it illustrates the cross-sectional view of the cavity and the diminutive sample during the CPM. It can be seen from FIG. 1 that a diminutive sample 130 is placed into a cavity 100 which is then excited. The dielectric characteristics of the diminutive sample 130 can be calculated from the volumes of the sample itself 130 and the cavity 100 and the changes in resonant frequency and the Q factors, which can be derived from comparing the measurements before and after the insertion of the sample 130.

Referring to FIG. 2A, it presents a cylindrical cavity with one end being a top end 200a and the other a bottom end 200b with both ends sealed to form a closed space between the top end 200a and the bottom end 200b. The cross-sectional line 2B-2B was cut along the direction of the arrows to formed a cross-sectional view of the cavity 200 as shown in FIG. 2B.

Referring to FIG. 2B, one must excite the cavity 200 and measure the resonant frequency and the Q factor of the cavity 200 before performing the CPM. Then a diminutive sample (not illustrated in FIG. 2B) will be placed into the cavity 200 in a manner that is shown in FIG. 1; after the insertion of the sample, the cavity 200 will be excited again in order to measure the changed resonant frequency and the Q factor. According to theory, the resonant frequency of the cavity in TM₀₁₂ mode is:

$${f}_{012} = \frac{c}{2 π} \sqrt{{( \frac{2.405}{a} )}^{2} + {( \frac{2 π}{l} )}^{2}}$$

c=3×108 m/s

a=radius of the inner wall of the cavity

l=length of the inner wall of the cavity

If a=1.85 cm, and l=7.7 cm, then the resonant frequency will be

f₀₁₂=7.33 GHz

After the insertion of the diminutive sample, the resonant frequency and the Q factor will change and the dielectric characteristics of the diminutive can be derived from these changes. It is important to note that the essential condition of the CPM is that the Q factor of the cavity must be higher than that of the diminutive sample; otherwise, the accuracy of the measurement will be affected.

Traditionally, the high Q factor cavity is TM₀₁₀ mode and uses transmission style as a way to excite the cavity. The Q factor of this kind is limited under 5000 due to the restraint of the cavity structure. In other words, when the Q factor of the measured dielectric material is greater than 5000, the resulting measurements will not be accurate, thus, it will be meaningless to carry out the CPM.

### SUMMARY OF THE INVENTION

It is therefore an object of the invention to provide a loop coupled microwave cavity excited by TM₀₁₂ mode microwave signal in order to provide a higher Q factor to the cavity for measuring the dielectric characteristics of the material having high Q factor.

The invention achieves the above object by providing a new loop coupled microwave cavity and its features are described in the following paragraphs.

The loop coupled microwave cavity consists of a cavity and a loop coupler. In the process of making the cavity, a copper pillar is drilled to form a hollow area and a step base is made and connected tightly to the hollow area in order to form the main body of the cavity. Then, a mushroom-shaped lock hole is made on the top of the cavity by drilling. The lock hole is to be used in connection to the loop coupler. A loop coupler has a receiving end and an exciting end of which the receiving end is connected to the outside circuit in order to receive the microwave signal while the exciting end is connected to the inner wall of the cavity in order to excite the cavity. In real-life applications, one can use a SMA connector having a long pin as the loop coupler. The connecting part can be used as a receiving end and the top of the long pin is folded to form the exciting end. The long pin of the SMA connector is placed into the cavity through the lock hole while the top of the long pin is connected to the inner wall of the cavity; then a microwave signal in TM₀₁₂ mode can be fed in to excite the cavity. On the other hand, the long pin and the lock hole form a coaxial structure, which can be viewed as a quarter-wavelength transformer. Therefore, the SMA connector serves not only as a loop coupler but also a transformer to increase the Q factor of the cavity. Furthermore, one side of the cavity can be drilled to form a side hole from which the diminutive sample can be placed into the cavity to perform the CPM.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (Prior Art) illustrates the cross-sectional view of the cavity when a diminutive sample is placed into the cavity in order to perform the CPM;

FIG. 2A (Prior Art) shows an illustration of a cylindrical cavity;

FIG. 2B (Prior Art) depicts the cross-sectional view of the cavity that is shown in FIG. 2A;

FIG. 3 shows an illustration of a loop coupled microwave cavity provided by the invention's preferred embodiment;

FIG. 4 shows the front view of the top end of the loop coupled microwave cavity shows in FIG. 3;

FIG. 5 shows the lateral view of the loop coupler shown in FIG. 3;

FIG. 6 shows the cross-sectional view of the loop coupled microwave cavity shown in FIG. 3, after it is assembled; and

FIG. 7 shows the cross-sectional view of the connection spot of the cavity's top end and the loop coupler shown in FIG. 6.

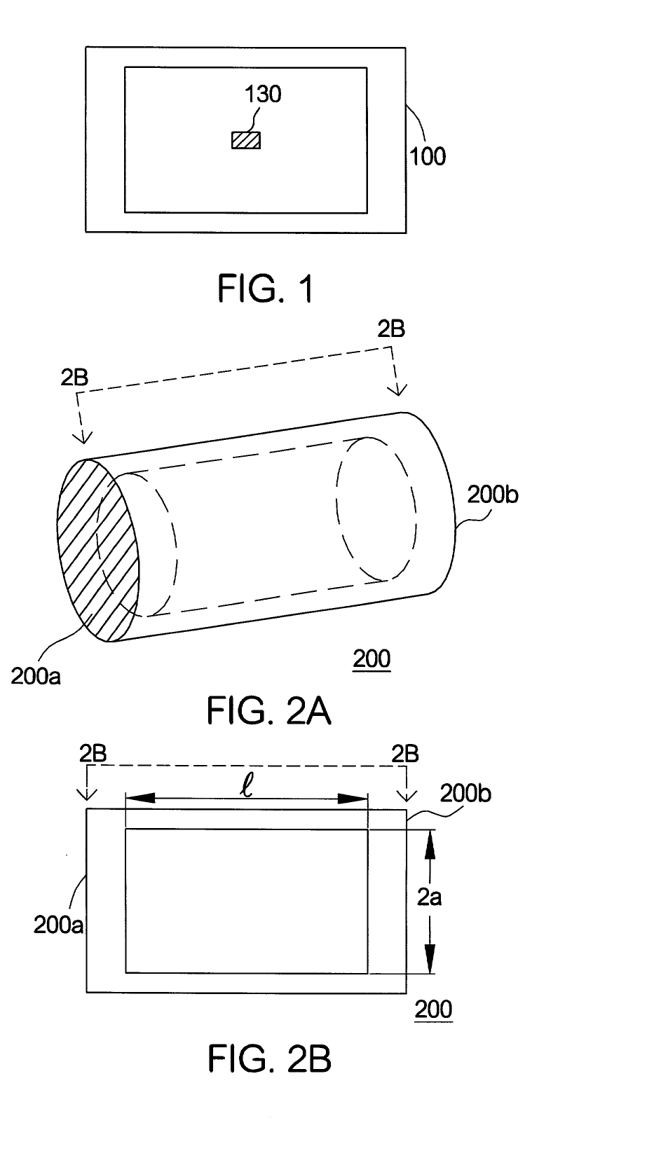

### DESCRIPTION OF THE PREFERRED EMBODIMENT

The geometric structure of the cavity can be either rectangular or cylindrical but the cylindrical cavity is preferred in real-life applications since the Q factor of a cylindrical cavity is higher than that of the rectangular cavity; among the cylindrical cavity, the TM₀₁ₙ and TE₀₁ₙ mode are frequently used. According to the references, a flat cylindrical cavity's (2a/l≧1, a=radius of the cavity, l=length of the cavity) TE₀₁ₙ mode has a Q factor much higher than that of the TM₀₁ₙ mode while a long cylindrical cavity's(2a/l≦1)TE₀₁ₙ and TM₀₁ₙ mode have Q factors that are close to each other. Thus, a long cylindrical cavity is often used in CPM. Ideally, the Q factor should be very high if there is no change in the geometric structure of the cavity, however, the addition of the base and coupler inevitably changes the original geometric, resulting in the degradation of the Q factor. As such, if a high Q factor is required, one must keep the cavity as close to its original structure as possible.

In order to preserve the original structure as much as possible, the invention provides a loop coupled microwave cavity that uses a reflection coupler to feed in the microwave signal. This reflection coupler has an advantage over the conventional transmission coupler; it only needs one coupler to perform the operation while the conventional one needs two. In this way, the invention minimizes the changes needed.

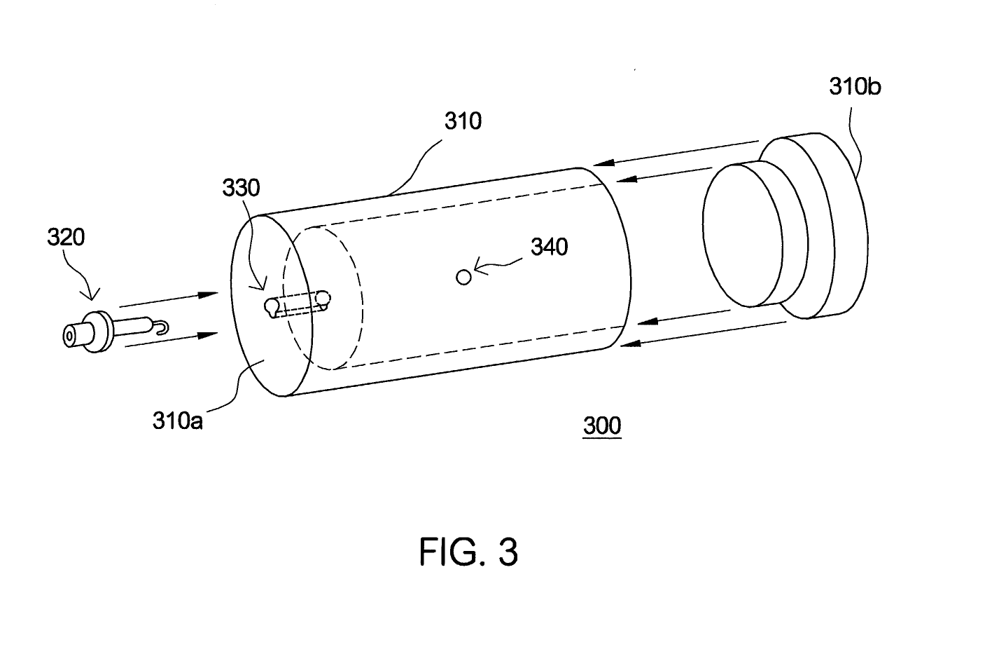

Referring to FIG. 3, it presents an illustration of a loop coupled microwave cavity provided by the invention's preferred embodiment. The loop coupled microwave cavity 300 consists of a cavity 310 and a loop coupler 320; there is a side hole 340 on the cavity 310 for inserting the diminutive sample (not illustrated in FIG. 3) into the cavity 310. Besides, a top end 310a of the cavity has a lock hole 330 connected to the cavity 310 which connects the cavity 310 and a loop coupler 320. In the process of making the cavity 310, a cylindrical metallic material, such as copper, can be used as the body of the cavity 310 and the metal is drilled to form a cavity 310. Then the same metal is used to make a step base as a bottom end 310b of the cavity 310 and applies the transition fit to connect the bottom end 310b and the cavity 310. In order to make the connection between the cavity 310 and the bottom end 310b of the cavity tighter, one can drill and spiral the connecting spot between the cavity 310 and the bottom end 310b of the cavity, then use the screw to make the connection tight in order to increase the Q factor of the cavity. The following paragraphs explain the loop coupler 320 and its connection with the lock hole 330.

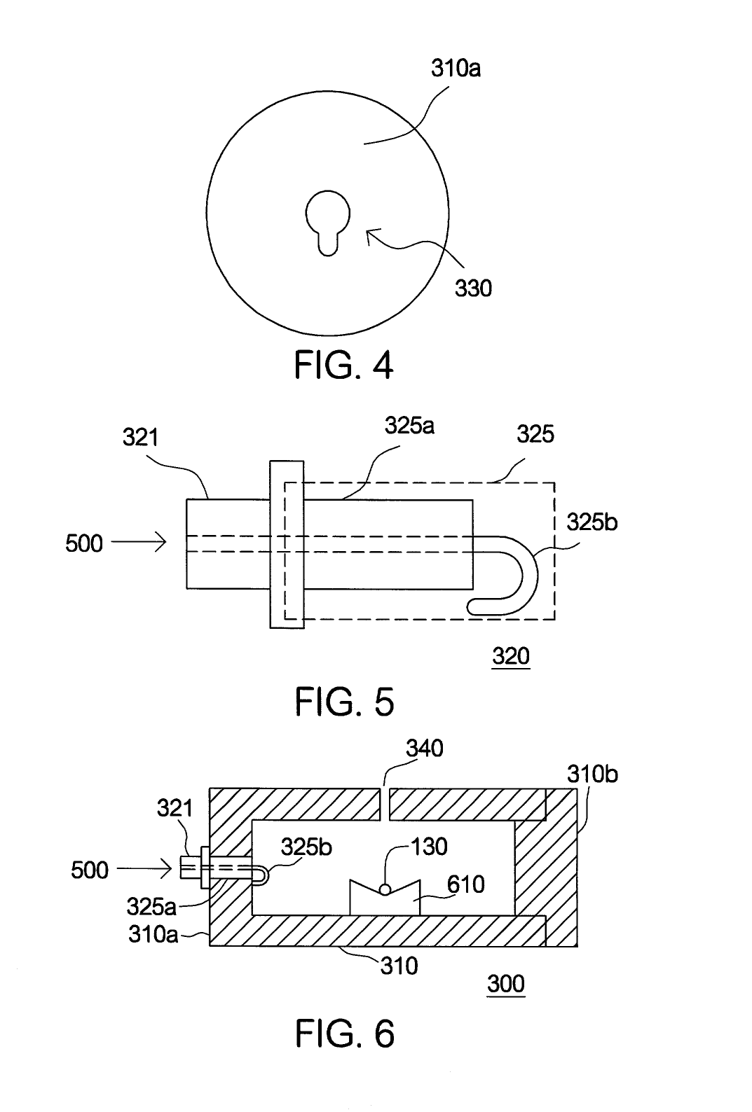

Referring to FIG. 4, it presents the front view of the top end 310a of the cavity. As can be seen, a lock hole 330 is on a top end 310a and connected to the cavity 310. The structure of the lock hole 330 is obtained by double-drilling: first, a big hole is drilled at the center of the circle and drilled through the top end 310a; second, a small hole is drilled at a place just next to the center of the circle and also drilled through the top end 310a. The two holes are partly overlapped and smoothed to make a mushroom-shaped lock hole structure that is shown in FIG. 4.

Referring to FIG. 5, it illustrates a lateral view of the loop coupler 320. In general, there are several ways to excite the cavity: probe style, loop style, iris style, etc . . . . One must choose a style that changes the original structure as little as possible in order to preserve a high Q factor. Therefore, the invention will choose a loop style to excite the cavity and use a SMA connector as a loop coupler 320. As illustrated in FIG. 5, the SMA connector has a co-axial structure and its long pin is an axis, which is covered by Teflon 325a. One end can be used as a receiving end 321 and can be connected to an outside circuit (not illustrated) in order to receive a microwave signal 500; the other end of the connector can be used as an exciting end 325 and applies microwave signal 500 to excite the cavity 310. The top of the long pin can be bent to make a loop coupling end 325b. In order to enable the Teflon 325a and the lock hole 330 to stick to each other, part of the Teflon 325a is trimmed so that the Teflon's 325a external diameter will be just a little bit shorter than the internal diameter of the bigger hole of the lock hole 330. In order to make a connection between the inner wall of the cavity 310 and the loop coupler 320, the exciting end 325 is placed in the lock hole 330 so the loop coupling end 325b can enter the cavity 310 through the lock hole 330. The external diameter of the Teflon 325a and the internal diameter of the lock hole 300 are designed in such a way that they can stick to each other. Thus, the loop coupler 320 will be installed solidly in the lock hole 330 as long as the exciting end 325 is placed into the lock hole 330. Then, by turning the loop coupler 320 around, the top end of the loop coupling end 325b will touch the inner wall of the top end 310a of the cavity. In other words, the exciting end 325 is connected to the inner wall of the cavity 310 through the lock hole 330 so when a microwave signal 500 is received, it will be used to excite the cavity 310. Of course, one can give the loop coupler 320 a screw at the top end 310a of the cavity 310 to make a firmer structure.

Referring to FIG. 6, it shows the cross-sectional view of the loop coupled microwave cavity 300 after it is assembled. Since the loop coupling end 325b uses a current to excite the cavity in order to get the TM mode, the loop coupling end 325b must be connected to the cavity. As illustrated, the loop coupler 320 is placed in the lock hole 330 and the loop coupling end 325b of the exciting end 325 is connected to the inner wall of the cavity 310. In the process of CPM, the positioning holder 610 can be placed into the cavity 310 first, and then the cavity 310 is excited in order to measure the resonant frequency and the Q factor. The next step is to insert the diminutive sample 130 through the side hole 340 and place it on the positioning holder 610 and then the cavity 310 is excited again to take the measurements of the resonant frequency and the Q factor. The dielectric characteristics of the diminutive sample 130 can be derived from a comparison of the changes in the Q factor and the resonant frequency, which is measured before and after the insertion of the sample, and the calculation of the volumes of the sample and the cavity. The expandable polyfoam can be used as the material of the positioning holder 610 because its relative dielectric permittivity (εᵣ) is nearly one, which is the same as that of the air (ε₀), so it will not cause much effect to the measurements.

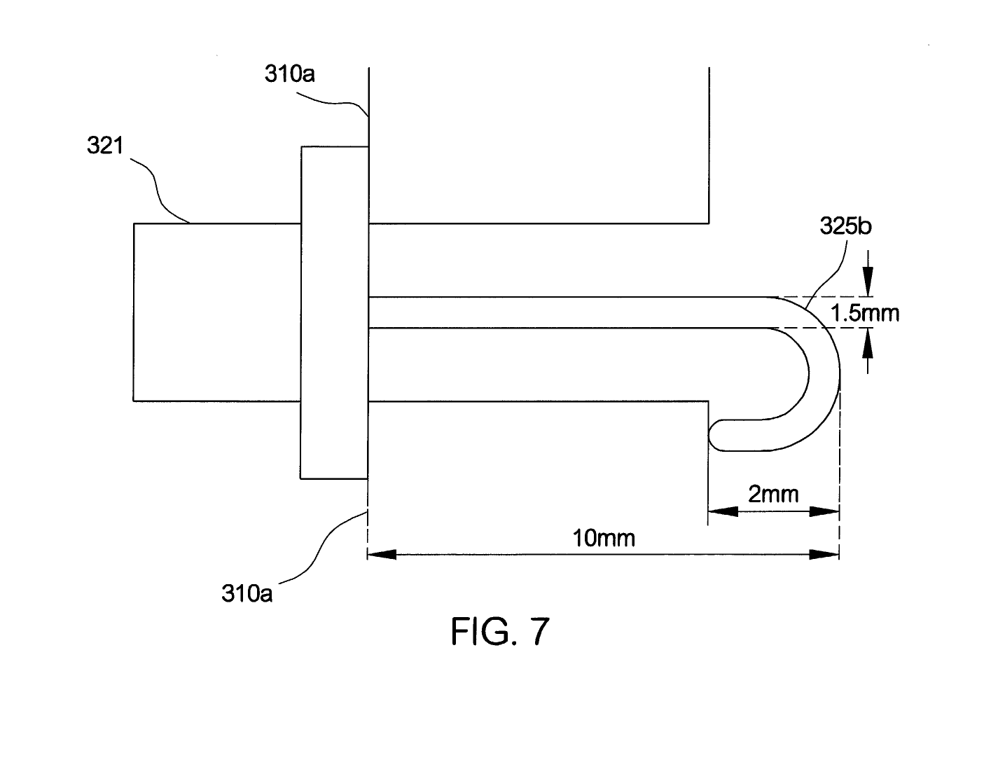

From the cross-sectional view, it can be seen that the long pin of the SMA connector is the axis, the thickness of the top end 310a is thicker and the long pin is inside it, so the long pin and the lock hole form a coaxial line. This coaxial structure make the combination of a quarter-wavelength (λ/4) transformer and the loop coupler 320 possible. Thus, the loop coupler 320 in the invention has the function of both loop coupling and transforming. Referring to FIG. 7, it illustrates the cross-sectional view of the connection spot of the cavity's top end 310a and the loop coupler 320. Using FIG. 7 as an example, the bending part of the loop coupling end 325b is 2 mm, the length in which the long pin inserted to the cavity 310 is 10 mm and the diameter of the long pin is 1.5 mm. Therefore, the length of the long pin's central line inside the cavity 310 is 10.5 mm. If this length is seen as a quarter of the wavelength, then the frequency can be calculated as 7.4 GHz in TM₀₁₂ mode. The exciting end 325, viewing from the receiving end 321, can be regarded as a quarter-wavelength coaxial line. At the resonant frequency, the impedance is regarded as an open circuit and Qₑ is infinite. In this way, the cavity retains its high Q factor. In practice, a network analyzer BP-8510 is used to measure the characteristics of the loop coupled microwave cavity 300, to obtain a central frequency of the TM₀₁₂ mode f₀₁₂=7.549 GHz, 3dB as the bandwidth BW=100 KHz, so the Q factor of the cavity in TM₀₁₂ mode is

Q=f₀₁₂/BW≅75,000

In the conventional setting, even though the Q factor of the cavity in TE₀₁ₙ mode can reach 50000, it is limited to measuring liquid or circularly flat solid samples. As well, the manufacturing of this kind of is very difficult. In comparison, the invention provides a loop coupled microwave cavity that is obviously improved from the conventional device.

The preferred embodiment of the invention that has been discussed will provide the following advantages;

1. a simple structure that is easy to make

2. uses a reflection style to excite the cavity to keep the cavity structure close to its original geometric structure

3. uses a loop coupler to provide transforming and loop coupling functions in order to keep the high Q factor

4. in TM₀₁₂ mode, the Q factor of the cavity can be higher than 75000 in order to measure the dielectric characteristics of a high Q factor

It is important to know that the invention applies SMA connector as the coupler to receive microwave signal and to excite the cavity. However, the SMA connector is not the only component that can be used to perform the function.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A loop coupled microwave cavity, comprising:
a cavity, wherein one end of the cavity is a top end having a lock hole; and
a loop coupler placed in the lock hole and connected to the cavity, wherein the loop coupler comprises:
a receiving end for receiving a microwave signal; and
an exciting end connected to the inner wall of the cavity through the lock hole, wherein the microwave signal transmit through the exciting end and excite the cavity.

2. The loop coupled microwave cavity according to claim 1, wherein the cavity has a side hole connected to the cavity for inserting a diminutive sample.

3. The loop coupled microwave device according to claim 2, wherein the loop coupler is for impedance transforming and loop coupling.

4. The loop coupled microwave device according to claim 2, wherein the loop coupler is a SMA connector.

5. The loop coupled microwave cavity according to claim 4, wherein the SMA connector is for impedance transforming and loop coupling.

6. The loop coupled microwave cavity according to claim 2, wherein the loop coupled microwave cavity is TM₀₁₂ mode.

7. The loop coupled microwave cavity according to claim 2, wherein the cavity is made of a metallic material.

8. The loop coupled microwave cavity according to claim 7, wherein the metallic material is copper.

9. The loop coupled microwave cavity according to claim 2, wherein the diminutive sample is made of a dielectric material.

10. The loop coupled microwave cavity according to claim 1, wherein the loop coupler is for loop coupling and impedance transforming.

11. The loop coupled microwave cavity according to claim 1, wherein the excited mode of the loop coupled microwave cavity is TM₀₁₂ mode.

12. The loop coupled microwave cavity according to claim 1, wherein the loop coupler is a SMA connector.

13. The loop coupled microwave cavity according to claim 1, wherein the SMA connector is for impedance transforming and loop coupling.

14. The loop coupled microwave cavity according to claim 1, wherein the cavity is made of a metallic material.

15. The loop coupled microwave cavity according to claim 14, wherein the metallic material is copper.

16. The loop coupled microwave cavity according to claim 1, wherein the diminutive sample is made of a dielectric material.
